(19) United States
(12) Patent Application Publication
(10) Pub. No.: US 2009/0155470 A1
(43) Pub. Date: Jun. 18, 2009

(54) Antimicrobial Glaze and Acid Resistant Porcelain for Enameled Steel Products

(76) Inventors: Ram Narayanan, Erlanger, KY (US); James Michael McHale, Hillsborough, NJ (US)

Correspondence Address: FROMMER LAWRENCE & HAUG, 745 FIFTH AVENUE- 10TH FL., NEW YORK, NY, 10151, US

(21) Appl. No.: 11/921,476

(22) PCT Filed: Jun. 5, 2006
(86) PCT No.: PCT/US2006/021706

§ 371 Date: Feb. 4, 2009

Related U.S. Application Data
(60) Provisional application No. 60/687,660, filed on Jun. 6, 2005.

(51) Int. Cl. C09D 5/00; B05D 3/02

(52) U.S. Cl. 427/372.2; 106/18.36

(57) ABSTRACT

The invention provides a cost-effective and practical acid resistant porcelain enamel with antimicrobial properties for steel substrates. The invention provides a porcelain enamel coating which has an optimum range of zinc content and other enamel constituents wherein outstanding antimicrobial performance is achieved without significant degradation of other important properties such as acid resistance.

### INCORPORATION BY REFERENCE

All documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

### FIELD OF THE INVENTION

The present invention relates to antimicrobial and acid resistant porcelain for use in enameled steel products. The invention provides for a cost-effective and practical antimicrobial and acid resistant porcelain and method for producing the same.

### BACKGROUND OF THE INVENTION

The Oligodynamic Effect is the term given to the ability of small amounts of heavy metals to exert a lethal effect on bacteria (from the Greek: oligos, small; dynamis, power). The effectiveness of heavy metals as antimicrobials is due to the high affinity of cellular proteins for metallic ions. Bacteria cells die due to the cumulative effects of ions within the cell, even if the concentration of ions in a solution is miniscule. Metals that generally show a strong oligodynamic effect are (in order of decreasing strength) Mercury, silver, copper, zinc, iron, lead, and bismuth. Among these metals, silver and zinc have been used in materials for various applications and industries, such as materials for use in medical devices, food processing products, textiles, and sanitary ware. Oligodynamic elements other than silver and zinc, either due to human toxicity or some incompatibility with the intended matrix material (e.g. changes in color), are rarely used as antimicrobial agents in material applications. Compared to zinc, silver and its salts exert a much stronger antimicrobial effect against common bacteria such as Staphylococcus aureus and Escherichia coli. Zinc oxide, however, generally shows much better efficacy than zilver against various fungi. Another practical factor from a manufacturing standpoint is that silver is far more expensive than zinc, with a market price over 100 times greater per unit weight.

U.S. Pat. No. 5,882,808 describes an antimicrobial enamel product obtained by adding silver compounds to an enamel formulation. The silver is added to the enamel slurry as a salt or as an oxide. The slurry is applied to a metal substrate and fired at a temperature generally exceeding 800° C. This approach can provide good antibacterial efficacy, but in practice, the level of silver required to obtain this effect results in an unacceptably large increase in the cost of the enamel. For example, a typical bathtub requires approximately 5 lbs. of enamel coating. Due to the relatively high vapor pressure of silver and its compounds at temperatures above 800° C., at least 1 wt % of an antimicrobial silver compound is needed to impart strong antimicrobial efficacy to the fired enamel body. A large part of this silver vaporizes and condenses on the walls of the kiln, which over time can build up to troublesome levels and result in manufacturing downtime. The current cost of antimicrobial silver compounds is roughly $100/lb, which at 1% loading results in an added manufacturing cost of $5 per bathtub. In order to maintain competitive profit margins, this cost requires a price increase that is well beyond what many consumers are willing to pay for the feature. Thus, there is a need for a more cost effective means for producing antimicrobial enamel products.

U.S. Pat. No. 6,303,183 describes an antimicrobial porcelain enamel coating and a method of preparing the coating. The porcelain enamel coating contains an anti-microbial agent comprised of silver disposed on a particulate support. The inventors demonstrated only a 40% reduction in bacterial count with 4% addition of the antimicrobial agent “MicroFree™ Z200” (Formerly available from Dupont Chemical Co. Now available as “ACT™ 200” from Airqual Corp.). This additive is described by Davies et al., in Adv. Mater. 1998, 10, 1264, and US EPA Registration Document 69897-4 as core zinc oxide particles (95.94 wt %) coated with a layer of metallic silver (0.24 wt %) and a second, outer coating of SiO₂. The current list price of ACT 200 is $30/lb. This is inexpensive for a silver-based antimicrobial compound, but at the required loading of 4 wt % in the 5 lbs of enamel required to make a typical bathtub, it yields an additional product cost of approximately $6 per unit. Thus, the inventors have not succeeded in developing a more cost-effective method for imparting antimicrobial properties to porcelain enamel.

Of the metals other than silver that have strong oligodynamic effect, zinc is most suited for use in enamel applications. Mercury, lead, and bismuth present toxicity and environmental issues, whereas iron and copper compounds would foreclose the possibility of producing white pieces. Zinc oxide is already used as a flux material in some chinaware glaze and porcelain enamel systems, albeit at levels too low to yield any significant antimicrobial effect. Japanese Patent Application 10-227686 describes an antimicrobial chinaware glaze formulation that contains 6-20 wt % of zinc compounds measured as zinc oxide. The inventors state that at least 6 wt % is necessary to obtain consistent antimicrobial efficacy, which is a relatively high loading requirement. The inventors did not explore the minimum concentration of zinc that gives consistent efficacy in porcelain enamel systems.

Porcelain enamels with greater than 6 wt % of zinc oxide have been commercialized for cast iron products (A. I. Andrews, 1935, Garrard Press, Champaign, Ill.). Enamel formulations for steel substrates differ from cast iron due to the need to match the thermal expansion properties of the glass layer to the greater thermal expansion of the steel substrate. Commercial enamel formulations for steel substrates rarely contain more than 1 wt % zinc oxide. In typical steel enamel formulations adapted for high thermal expansion, increasing the level of zinc oxide has a negative impact on the acid resistance of the material. Plumbing code requirements in the US require a minimum acid resistance score of “A” as measured by the ASTM C282 Citric Acid Spot Test. Typical enamel formulations for steel substrates fall below this requirement with as little as 2 wt % zinc oxide. This presents a significant barrier to utilization of the antimicrobial properties of zinc in enameled steels.

### SUMMARY OF THE INVENTION

As is evident from the above analysis, there is a need for a cost-effective and practical (from a manufacturing viewpoint) approach to providing an acid resistant porcelain enamel with antimicrobial properties for steel substrates. The instant invention provides a solution to this problem. A cost-effective and practical antimicrobial porcelain enamel system can be achieved by specific chemical adjustments to the enamel formulation that counteract the negative impact of zinc oxide on acid resistance. The inventors have found the optimum range of zinc content and other enamel constituents wherein outstanding antimicrobial performance can be achieved without significant degradation of other important properties such as acid resistance.

Although zinc oxide has a detrimental effect on acid resistance of enamel, the inventors have found that this effect can be counteracted by addition of other materials that have a positive influence on acid resistance. Alumina, silica, titania, zirconia, tin oxide, their solid solutions, and compounds thereof can have a positive influence on acid resistance. The inventors have surprisingly found that even small additions (i.e., below the 6% required for chinaware glaze) of these materials in combination with zinc oxide can yield a porcelain enamel that meets all code requirements and properties and displays outstanding antimicrobial efficacy at a fraction of the cost of the methods previously known.

The present invention is an antimicrobial and acid resistant enamel coating, and a method of producing the same, for a steel substrate, comprising ZnO in an amount, for example, between 1.0 and 6.0 percent by weight, and an amount of at least one second substance. The second substance may be alumina, silica, titania, zirconia, tin oxide, or a combination of these substances. The amount of the at least one second substance is preferably not less than 1 percent by weight less than the percent by weight amount of ZnO. The enamel coating having an antimicrobial efficacy of 95 percent or greater as measured in accordance with JIS Z2801, and having at least an “A” rating for acid resistance as measured in accordance with the ASTM C282 Citric Acid Spot Test.

These and other embodiments are disclosed or are obvious from and encompassed by, the following detailed description.

### BRIEF DESCRIPTION OF THE DRAWINGS

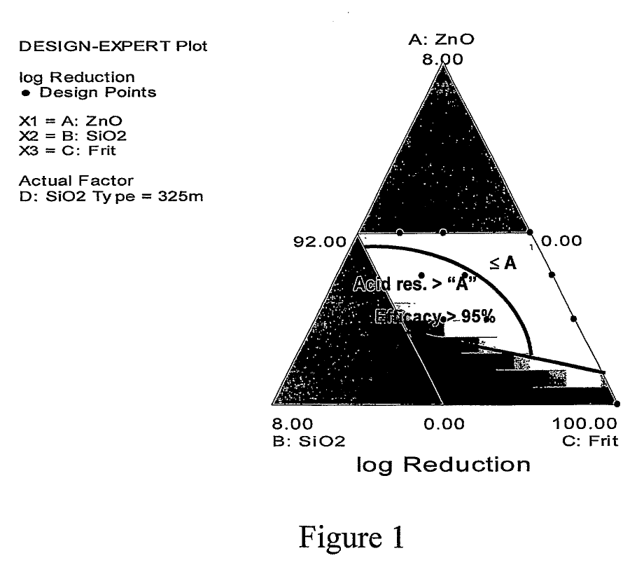

These and other objects and features are illustrated and described in the following specification to be read in conjunction with FIG. 1 which is a diagram charting the acid resistance and antimicrobial efficacy of enamel compositions against the percentage by weight of ZnO and SiO2. The diagram demonstrates that enamel compositions with greater than about 1 percent by weight ZnO display an antimicrobial efficacy above 95%. The diagram further demonstrates that incorporating an amount of a second substance (in this case SiO2) in amounts near to those of the ZnO enables the composition to maintain acid resistance at an acceptable level.

### DETAILED DESCRIPTION OF THE INVENTION

The present invention encompasses an antimicrobial and acid resistant enamel coating for a steel substrate, comprising ZnO and an amount of at least one second substance. The second substance may be alumina, silica, titania, zirconia, tin oxide, or a combination of these substances.

The present invention further provides a method of producing an enamel coated porcelain product on a steel substrate comprising (1) preparing a slurry containing a first amount of ZnO, a second amount of a substance selected from the group: alumina, silica, titania, zirconia, and tin oxide, and a third amount of glass frit; (2) coating a steel substrate with a ground coat enamel; (3) spray coating the slurry on top of the ground coat enamel; and (4) firing the product to form the enamel coated porcelain product.

The first amount of ZnO may preferably be between 1.0 and 6.0 percent by weight. The second amount may preferably be not less than 1.0 percent by weight less than the first amount of ZnO.

The enamel coated porcelain product has an antimicrobial efficacy of 95 percent or greater as measured in accordance with JIS Z2801. The enamel coated porcelain product has at least an “A” rating for acid resistance as measured in accordance with the ASTM C282 Citric Acid Spot Test.

A typical composition for an enamel cover coat for steel substrates is given in Table 1. Enamel samples were prepared using this formulation and varying additions of zinc oxide and a second material to improve acid resistance. In this example, two types of silicon dioxide were used as the acid resistance improving material, Aerosil A200 fumed silica from Degussa and −325 mesh crystalline silica. The zinc oxide and silica were added as mill additions to 100 parts of the enamel slurry formulation in Table 1. The maximum zinc oxide level in Table 2, of 4 parts therefore corresponds to 5.6 wt % zinc oxide on a dry enamel basis. The enamel slurry was sprayed onto 6″×6″ steel sheets that had been pre-coated with a ground coat enamel formulation. These sheets were then fired at a temperature of 800° C. to form the final enamel coating.

TABLE 1
Typical cover coat enamel formulation for steel substrates.

| Material | Parts by mass |
|---|---|
| Glass frit* | 100 |
| Titanium dioxide | 1.92 |
| Bentonite | 0.34 |
| Potassium nitrite | 0.11 |
| Potassium carbonate | 0.29 |
| Magnesium | 0.14 |
| Water | 42.1 |

*SE-2671 from Pemco, Inc., Baltimore, MD.

TABLE 2
Sample compositions and results of enamel property tests.

| | | | | | | | | Bacteria | |
|---|---|---|---|---|---|---|---|---|---|
| | | | | | | | | count after | % Reduction |
| Sample | ZnO | SiO2 | Type of | Acid | | | | 24 h contact | relative to |
| ID | Parts | Parts | SiO2 | Resistance | Gloss Ave | Avg DE | Avg Db | time (cfu) | Control |
| 2C3 | 0 | 0 | 325m | A | 59.2 | 0 | 0 | 520 | 0.0% |
| 2B3 | 2 | 3 | A200 | A | 62.75 | 1.938 | −1.759 | 8 | 98.5% |
| 2B2 | 2 | 2 | A200 | A | 63.15 | 1.677 | −1.485 | 5 | 99.0% |
| 2A3 | 2 | 3 | 325m | A | 60.6 | 0.675 | −0.515 | 2 | 99.6% |
| 3A3 | 3 | 3 | 325m | A | 61.95 | 0.696 | −0.255 | 2 | 99.6% |
| 3B3 | 3 | 3 | A200 | A | 62.4 | 2.253 | −2.105 | 2 | 99.6% |
| 2A2 | 2 | 2 | 325m | B | 61.4 | 0.553 | −0.37 | 1 | 99.8% |
| 2C2 | 2 | 0 | 325m | B | 62.55 | 0.761 | −0.306 | 1 | 99.8% |
| 3A2 | 3 | 2 | 325m | A | 60.4 | 0.718 | −0.335 | 1 | 99.8% |
| 3B2 | 3 | 2 | A200 | A | 61.25 | 1.505 | −1.194 | 1 | 99.8% |
| 3C2 | 3 | 0 | 325m | B | 58.95 | 0.519 | 0.001 | 1 | 99.8% |
| 4A2 | 4 | 2 | 325m | C | 61.25 | 0.356 | 0.293 | 1 | 99.8% |
| 4A3 | 4 | 3 | 325m | C | 59.7 | 0.473 | 0.462 | 1 | 99.8% |
| 4B2 | 4 | 2 | A200 | B | 63.1 | 1.25 | −0.866 | 1 | 99.8% |
| 4B3 | 4 | 3 | A200 | B | 60.25 | 1.537 | −1.444 | 1 | 99.8% |
| 4C2 | 4 | 0 | 325m | C | 59.95 | 0.756 | 0.708 | 1 | 99.8% |

Antibacterial efficacy was measured using the standard JIS Z2801 and performed by Industrial Microbiological Services Laboratory in the UK (IMSL). Each sample was inoculated with 3.4×10⁴ colony forming units of Staphylococcus aureus. Live bacteria counts were taken after 24 h of contact with the surface at 35° C. (see Table 2). As can be seen in Table 2, significant reductions in bacterial count can be achieved with as little as 2 parts zinc oxide in porcelain enamel materials. However, as can be seen in the results for sample 2C2, even 2 parts of zinc oxide can cause failure (i.e. a “B” rating) for acid resistance. Table 2 shows that this drop in acid resistance can be counteracted with addition of silica. In fact, 3 parts zinc oxide can be added if it is accompanied by addition of 3 or more parts of silica. The type of silica added (fumed vs. −325 mesh) had no significant effect on this improvement.

Analysis of the set of results in Table 2 reveals a region of space in the ZnO—SiO2-Frit phase diagram that gives satisfactory levels of antibacterial efficacy (defined here as ≧95% or ≧1.3 Log reduction relative to the untreated control enamel) and an A rating for acid resistance, as can be seen in FIG. 1.

To demonstrate the significant improvement of the current invention over the previous formulations, consider sample 3A3 in Table 2. This sample was prepared with 3 parts zinc oxide and 3 parts −325 mesh silica added to 100 parts of standard enamel slurry. The antibacterial efficacy for this sample was 99.6% reduction relative to the 0% zinc control, and the acid resistance rating was A. The current cost of zinc oxide and silica are roughly $0.9/lb and $0.06/lb, respectively. The current cost of glass frit for enamel is over $0.75/lb. Assuming that the same thickness of enamel is applied to a product, zinc oxide and silica replace frit in the final enamel coating. The current invention, therefore, can produce antimicrobial enamel at a cost per bathtub that is $0.11 lower than a standard enamel.

FIG. 1 is a diagram charting the acid resistance and antimicrobial efficacy of enamel compositions against the percentage by weight of ZnO and SiO2. The diagram demonstrates that enamel compositions with greater than about 1 percent by weight ZnO display an antimicrobial efficacy above 95%. The diagram further demonstrates that incorporating an amount of a second substance (in this case SiO2) in amounts near to those of the ZnO enables the composition to maintain acid resistance at an acceptable level. The region of space on the diagram that is above the 95% efficacy line and to the inside of the “A” rated acid resistance line in the ZnO—SiO2-Frit phase diagram defines the enamel compositions of the present invention that satisfy both efficacy and acid resistance requirements for porcelain enamel. Additionally, alumina, titania, zirconia, tin oxide, their solid solutions, and compounds thereof can be used to have a positive influence on acid resistance.

The invention was also demonstrated on a particular enamel formulation given in Table 3. Enamel samples were prepared using this formula and varying additions of zinc oxide and −325 mesh crystalline silica. The zinc oxide and silica were added as mill additions on a dry weight percentage basis to the enamel slurry formulation in Table 3. The enamel slurry was sprayed onto 6″×6″ steel sheets that had been precoated with a ground coat enamel formulation. These sheets were then fired at a temperature of 820° C. to form the final enamel coating.

The results of enamel properties analyses are presented in Table 4. The base enamel has a higher acid resistance, partially due to the higher firing temperature. However, the addition of >3 wt % ZnO drops the acid resistance below an A rating. As can be easily seen in data provided in Table 4, addition of SiO₂ regains the acid resistance. For example, sample GZ8 with 4 wt % ZnO and 4 wt % SiO₂ scored an AA for acid resistance and sample GZ12, with 5 wt % ZnO and 4 wt % SiO₂ scored an A.

Moreover, the melting of the zinc oxide into the frit surprisingly and significantly increases the acid resistance of the resulting porcelain.

TABLE 3
Cover coat enamel formulation for steel substrates.

| Material | Parts by mass |
|---|---|
| Glass frit* | 100 |
| Titanium dioxide | 4.00 |
| Bentonite | 0.30 |
| Potassium nitrite | 0.11 |
| Potassium carbonate | 0.29 |
| Magnesium | 0.14 |
| Water | 42.1 |

*50% VS516 and 50% VS517 from A O Smith Co.

TABLE 4
Sample compositions and results of enamel property tests.

| Sample | Wt % | | | Acid | |
|---|---|---|---|---|---|
| ID | ZnO | Wt % SiO2 | Gloss | Resistance | Delta E |
| GZ1 | 5.00 | 0.00 | 57.7 | B | 1.45 |
| GZ2 | 3.00 | 4.00 | 60.2 | AA | 0.52 |
| GZ3 | 5.00 | 4.00 | 60.4 | A | 1.42 |
| GZ4 | 5.00 | 2.00 | 60.6 | B | 1.42 |
| GZ5 | 4.33 | 1.33 | 60.3 | B | 0.62 |
| GZ6 | 3.67 | 2.67 | 59.8 | A | 1.16 |
| GZ7 | 4.50 | 3.00 | 60.6 | A | 1.33 |
| GZ8 | 4.00 | 4.00 | 60.8 | AA | 0.81 |
| GZ9 | 3.00 | 0.00 | 60.7 | AA | 0.95 |
| GZ10 | 1.00 | 0.00 | 60.5 | AA | 0.21 |
| GZ11 | 3.00 | 0.00 | 60.2 | AA | 0.64 |
| GZ12 | 5.00 | 4.00 | 61.3 | A | 1.14 |
| GZ13 | 1.00 | 0.00 | 61 | AA | 0.21 |
| GZ14 | 3.00 | 2.00 | 60.8 | AA | 0.65 |
| GZ15 | 4.00 | 0.00 | 60.8 | B | 1.30 |

The invention will now be further described by way of the following non-limiting examples.

### EXAMPLES

### Example 1

An antimicrobial and acid resistant enamel coating for a steel substrate, comprising: (1) an amount of ZnO between 1.0 and 6.0 percent by weight; and (2) an amount of at least one second substance selected from the group: alumina, silica, titania, zirconia, and tin oxide, wherein said amount of said at least one second substance is not less than 1 percent by weight less than the percent by weight amount of ZnO.

### Example 2

An enamel coating for a steel substrate containing a first amount of ZnO, and a second amount of at least one second substance, wherein the enamel coating has an antimicrobial efficacy of 95% or greater as measured in accordance with JIS Z2801 and wherein the enamel coating has at least an “A” rating for acid resistance as measured in accordance with the ASTM C282 Citric Acid Spot Test.

### Example 3

A method of producing an enamel coated porcelain product on a steel substrate comprising: (1) preparing a slurry containing a first amount of ZnO, a second amount of a substance selected from the group comprising alumina, silica, titania, zirconia, and tin oxide, and a third amount of glass frit; (2) coating a steel substrate with a ground coat enamel; (3) spray coating the slurry on top of the ground coat enamel; and (4) firing the product to form the enamel coated porcelain product.

Having thus described in detail the preferred embodiments of the present invention, it is to be understood that the invention defined by the above paragraphs is not to be limited to the particular details set forth in the above description. Many apparent variations thereof are possible without departing from the spirit or scope of the present invention.

In this application, terms such as “comprises,” “comprised,” “comprising,” and the like, can have the meaning attributed to them by U.S. patent law; e.g., they can mean “includes,” “included,” “including,” respectively; and terms such as “consisting essentially of” and “consists essentially of” have the meaning ascribed to them by U.S. patent law, e.g., they allow for elements not explicitly recited but exclude elements that are found in the prior art or that affect a basic or novel characteristic of the invention.

Citation or identification of any document in this application is not an admission that such document is available as prior art to the present invention.

What is claimed is:

1. An antimicrobial and acid resistant enamel coating for a steel substrate, comprising:
an amount of ZnO between 1.0 and 6.0 percent by weight; and
an amount of at least one second substance selected from the group: alumina, silica, titania, zirconia, and tin oxide, wherein said amount of said at least one second substance is not less than 1 percent by weight less than the percent by weight amount of ZnO.

2. The enamel coating of claim 1 having an antimicrobial efficacy of 95 percent or greater as measured in accordance with JIS Z2801.

3. The enamel coating of claim 1 having at least an “A” rating for acid resistance as measured in accordance with the ASTM C282 Citric Acid Spot Test.

4. An enamel coating for a steel substrate containing a first amount of ZnO, and a second amount of at least one second substance, wherein the enamel coating has an antimicrobial efficacy of 95% or greater as measured in accordance with JIS Z2801 and wherein the enamel coating has at least an “A” rating for acid resistance as measured in accordance with the ASTM C282 Citric Acid Spot Test.

5. The enamel coating of claim 4 wherein the first amount of ZnO is between about 1.0 and 6.0 percent by weight.

6. The enamel coating of claim 4 wherein the second substance is selected from the group comprising alumina, silica, titania, zirconia, and tin oxide.

7. The enamel coating of claim 6 wherein the second amount of at least one second substance is not less than 1.0 percent by weight less than the first amount of ZnO.

8. A method of producing an enamel coated porcelain product on a steel substrate comprising:
preparing a slurry containing a first amount of ZnO, a second amount of a substance selected from the group comprising alumina, silica, titania, zirconia, and tin oxide, and a third amount of glass frit;
coating a steel substrate with a ground coat enamel;
spray coating the slurry on top of the ground coat enamel; and
firing the product to form the enamel coated porcelain product.

9. The method of claim 8 wherein the first amount of ZnO is between 1.0 and 6.0 percent by weight.

10. The method of claim 8 wherein the second amount is not less than 1.0 percent by weight less than the first amount of ZnO.

11. The method of claim 8 wherein the enamel coated porcelain product has an antimicrobial efficacy of 95 percent or greater as measured in accordance with JIS Z2801.

12. The method of claim 8 wherein the enamel coated porcelain product has at least an “A” rating for acid resistance as measured in accordance with the ASTM C282 Citric Acid Spot Test.
